(19) United States
(12) Patent Application Publication
(10) Pub. No.: US 2007/0094064 A1
(43) Pub. Date: Apr. 26, 2007

(54) METHOD FOR FINANCIAL SYSTEM PROCESS AUTOMATION COMPRISING SCHEDULING AND SCOPING

(75) Inventors: STEVE YANKOVICH, SAN JOSE, CA (US); NATHAN HOOVER, LOS GATOS, CA (US); RAJESH BHATIA, HAYWARD, CA (US); ARTHUR ARDIZZONE, CUPERTINO, CA (US); DAVE SPRAGUE, SCOTTS VALLEY, CA (US); HAN-SHEN YUAN, SUNNYVALE, CA (US); YIM LEE, SAN JOSE, CA (US)

Correspondence Address: PATENTRY, P.O. BOX 151616, SAN RAFAEL, CA, 94915-1616, US

(73) Assignee: MOVARIS CORPORATION, SAN JOSE, CA (US)

(21) Appl. No.: 11/611,755

(22) Filed: Dec. 15, 2006

Related U.S. Application Data
(63) Continuation-in-part of application No. 10/710,433, filed on Jul. 10, 2004.

(51) Int. Cl. G05B 19/418; G06F 9/46

(52) U.S. Cl. 705/8

(57) ABSTRACT

A method for financial system process automation comprising a first process for scheduling financial account tasks which are in-scope and a second process for evaluating rules for placing financial account tasks “in-scope”. A method for efficiently and systematically selecting tasks for scheduling from a list of conditionally needed tasks that would be wasteful to consider on a daily basis.

### CROSS-REFERENCE TO RELATED APPLICATIONS

The present application is a continuation in part of US patent application Ser. No. 10/710,433 filing date Jul. 10, 2004, first named inventor Yankovich, titled: “Apparatus, method, and system for documenting, performing, and attesting to internal controls for an enterprise”.

### BACKGROUND

Financial accounting tasks can include process or workflow tasks around accounting controls (e.g. Sarbanes Oxley), the financial close process, financial planning and analysis, account reconciliation, financial reporting/statement preparation, and government required forms. These tasks can number in the tens of thousands in a single month. Presently these tasks are very costly to perform as they are largely manual which also makes them error prone. Being largely manual and so burdensome results in many organizations not performing these tasks as often as they should, performing them inconsistently, or not at all. That leaves what could be financially material problems or issues to fester and also results in inaccurate financial reporting.

Some financial accounting tasks are nearly always done. Some financial accounting tasks may be defined but have been determined to be unnecessary and thus never or rarely done. But a very large number of financial accounting tasks may be occasionally necessary on a conditional basis. The financial tasks which are the subject of the present invention revolve around the list of financial accounts. Accounting tasks are associated with a type of account (e.g. cash accounts consists of a list of accounts dealing with cash), business units or entities and a financial operation such as closing a period, reconciliation, defining, applying, testing or attesting to controls.

Rules can be written to schedule certain tasks for a financial account, or group of financial accounts, for business units or entities based on financial account balances, change in balances, comparison with other financial account balances, or even random sampling for audit and control. Consider that a scheduling process which runs daily to track progress on tasks which have been assigned and to assign new tasks which are triggered by the financial calendar could be excessively stressed to further consider all possible conditional tasks each day. This would be obviously wasteful if the account balances on which the conditions depend do not change on a daily basis or as frequently as the scheduling process is executed.

In conventional financial systems supporting large multinational corporations, there may be a complex matrix of business entities and financial accounts. Each combination of business entity and financial account has a number of tasks associated with it for financial close, financial control, and reconciliation. Some small number of these tasks occur regularly and must be scheduled with plans and assigned resources. A larger number of tasks occur infrequently and should be done only when there is material benefit of performing these tasks. While every financial account should have controls and reconciliation tasks, some may be silly, wasteful, and time consuming to apply too frequently to financial accounts which exhibit low balances, stagnancy, or irrelevance to the health of an enterprise. Nor should the decision of which controls or reconciliations to defer remain undocumented or arbitrary as may be the case in manually managed systems because there will be natural discontinuity of personnel and philosophy over time.

These tasks are more data driven rather than schedule driven. A rule may be written to cause a task to be performed only when one or more account balances have a mathematical relationship, change substantially, or reach a value. It may be appreciated that a scheduling process would not be an efficient system for evaluating ten thousand rules based on account balances each day of the financial calendar. The problem to be solved is selecting from a potentially large number of tasks to be scheduled based on priorities or significance.

Thus it can be appreciated that what is needed is a system which not only automates (i.e. scheduled, assigned, nagged users, and provided task status and analysis) these tasks but could use intelligent rules to determine which tasks could be skipped (or shouldn't be) each schedule cycle. Such a system would manage a large number of conditional tasks which depend on the values of account balances which may be infrequently updated without impacting the workload of the scheduler until such time as certain criteria are fulfilled.

### SUMMARY OF THE INVENTION—SCOPING

The present invention is the addition of an independently operating scoping method to a conventional business process automation scheduling system. Significant efficiency and capability results from keeping all conditional tasks hidden from the scheduler until certain criteria are fulfilled and only then placing them into the queue of tasks that may be scheduled. Scoping in the present invention uses financial account balances as the main variable in rules that base their result on a comparison, change, calculation using a current value and prior value of said accounts.

### DETAILED DESCRIPTION

We define a task list to comprise at least one of the following: a task, a plurality of tasks, a task list, and a plurality of task lists. Thus there may be a task list that is hierarchical, being made up of other task lists and those task lists may contain other task lists. A list may always contain a single task. We will use task list in this recursive meaning. A task list even one containing only an individual task must have at least one scoping rule, and at least one business unit linked to it. Without a business unit associated, there is no one to assign the task to. Without a scoping rule, there is no input to a scoping engine to set scope in or scope out for the purpose of scheduling. The present invention comprises a scheduling method, a scoping method, and a task list, wherein a task list comprises a link to a business unit list, a link to a scoping rule list, and at least one of a task and a task list.

Similarly, a business unit list may be comprised of one or more business units or one or more business unit lists and a combination of business units and business unit lists. That is, formally, a business unit list comprises at least one of a business unit and a business unit list. And, a scoping rule list comprises at least one of a scoping rule and a scoping rule list.

The invention further comprises a financial account list which is made up of one or more financial accounts or one or more lists of financial accounts, or any combination thereof. Formally, the present invention further comprises at least one financial account list wherein a financial account list comprises at least one of a financial account and a financial account list and wherein the financial account is linked to at least one business unit list. All financial accounts have to belong to some business unit. While there may be tasks that do not depend on any financial accounts, every financial account must be associated to some task or there would be no point in having them in a process automation scheduling system. Financial accounts deal with some quantity parameterized as a national currency or mutually agreed money such as a Euro and thus must have a financial account balance. A financial account balance is either a current financial account balance for the latest financial period or a previous financial account balance of a historical period.

In an embodiment the present invention comprises two main components (that is, lists) comprising financial account lists and task lists. In an embodiment each list contains types (or groups or lists) of lists. In an embodiment, lists form a hierarchical organization (like a typical organization chart) whereby the higher the item is in the hierarchical structure the more likely it is to have items below it and thus part of its group.

Additional lists like business units/entities or any other list allows for being either more granular OR creating one-to-many relationships. The one-to-many relationship creates types (groups) within the lists of financial statements and business units, or any additional lists created.

In one embodiment, the present invention comprises at least two of
FAT, Financial account types (comprising at least one FA, Financial account),
BUT, Business Unit type (may be equivalent to BU if BU's are hierarchical comprising at least one BU, Business Unit), and
TT, Task type, (comprising at least one T, Task) wherein a financial account has a
FAB, financial account balance.
   A scoping rule, when evaluated, determines the scoping value of scope in or scope out for a task list which of course could degenerate to a single task associated with a single business unit. More usefully, a scoping rule evaluates variables to determine the scoping value of at least one task list associated with at least one business unit list wherein the scoping value in one of scope in and scope out and wherein the variables are at least one of
FA, Financial accounts,
FAT, Financial account types (comprising groups of financial accounts),
BU, Business Units, BUT, Business Unit type (may be equivalent to BU if BU's are hierarchical),
T, Task
TT, Task type,
task completion history, and
FAB, financial account balance
wherein financial account balance comprises at least one of a current financial account balance and a previous financial account balance.

In the present invention the scoping value determines the operation of the scheduler to run or not run at least one task or many tasks.

An embodiment of the present invention applies a scoping rule to a task list and a business unit list. The evaluation of the scoping rule causes the in-scope finding to be designated on at least one tasks to be performed on one business unit. The invention further comprises applying a rule task list and a business unit list the rule being conditional on a value of at least one financial account associated with the business unit.

In an embodiment of the present invention a financial account named Retail_Register_Cash is of a type Cash which has at least one task linked to it. The Retail_Register_Cash account is relevant to some but not all of the business entities in the enterprise so at least one business entity is linked to it.

In an embodiment a rule could specify that tasks related to Retail_Register_Cash are out of scope in every business unit where Retail_Register_Cash is less than a fixed value.

This could be implemented as having all tasks in scope and the rule putting them out of scope or as having all tasks default to out of scope and the inverse of the rule putting selected tasks in scope.

In an embodiment, where two rules conflict as to whether a task is in scope or out of scope, a resolution could determine dominance of in scope or out of scope.

In an embodiment, a rule could be identified as dominant over any other rule.

In an embodiment, rules may be evaluated on parameters comprising a financial account, a type of financial account, a hierarchical framework of controls and activities, a control activity, a business unit, a business entity, a close task, a close period, and combinations of these parameters and a plurality of types of data related to financial systems, processes and structure could play a role in the invention.

An embodiment of the present invention discloses the principle of scoping applied to financial controls:

Definition List 1

| Term | Description |
|---|---|
| In-Scope | A control that should be kicked-off. |
| Scoping profile | A set of descriptors that designate conditions for if a |
| | control should be disabled. |
| Scoping Rule | A heuristic for making scoping profile recommendations. |
| CHM | Control Hierarchy Manager |
| Requirements | Automate internal-controls documentation and testing |
| | activities |
| | Everything is in one place, total visibility instead of |
| | relying on hundreds of spreadsheets |
| Favorite | Complete visibility on what controls are in place to |
| functionality | support each account |
| Functionality | Determine which accounts are ″significant″ and whether |
| desired | they're in scope |
| | Provide greater transparency between entity-level |
| | controls, business process controls and IT controls |
| Requirements | Help business managers monitor controls is use at each |
| | departments. |
| | Dashboard to determine whether company managers |
| | have verified that controls are in place. |
| | Eliminate the use of Excel spreadsheets and Microsoft |
| | Office Visio software to monitor controls |
| Favorite | Control Dashboard to ″drill down″ to control deficiency |
| functionality | to determine remediation and testing status |
| Functionality | User-defined [data] fields to load financial data into the |
| desired | system |
| | “determine which accounts are ″significant″and whether |
| | they're in scope” |

### BRIEF DESCRIPTION OF DRAWINGS

FIG. 1 is a flowchart of the method of scoping

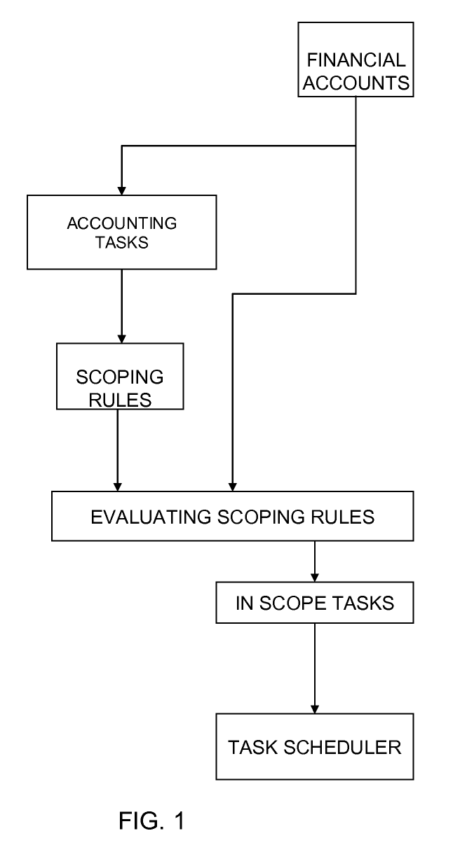

FIG. 2 is a flowchart of scoping using account balances

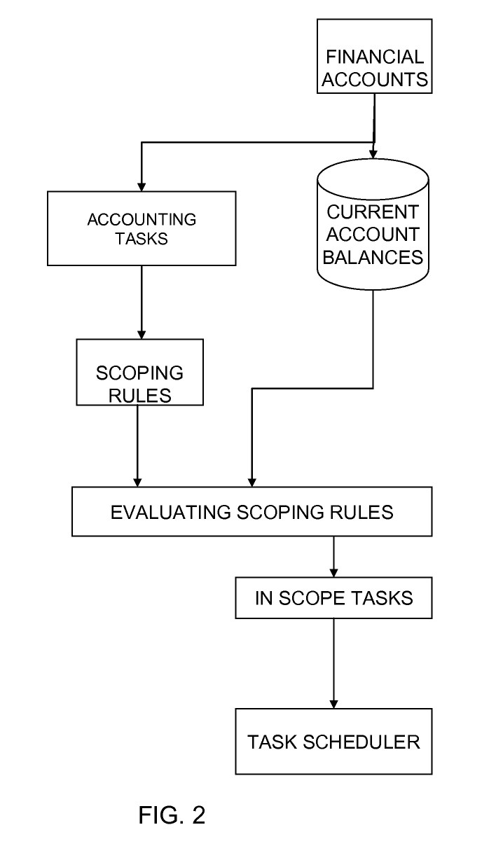

FIG. 3 is a flowchart of scoping comparing current and previous balances

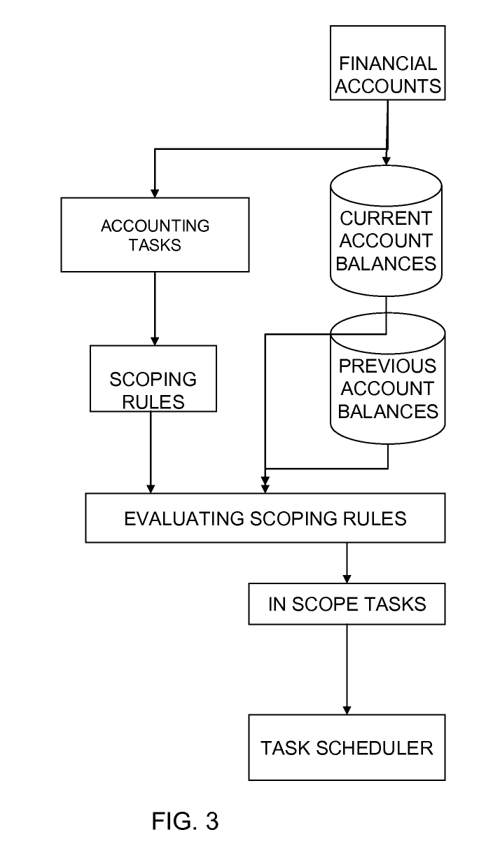

FIG. 4 is a flowchart of scoping considering past history

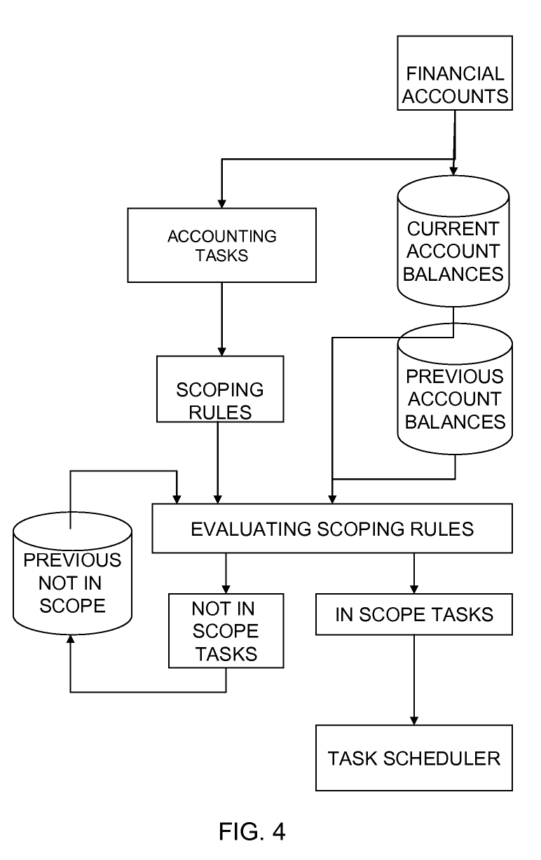

FIG. 5 is a flowchart for scoping different accounting tasks

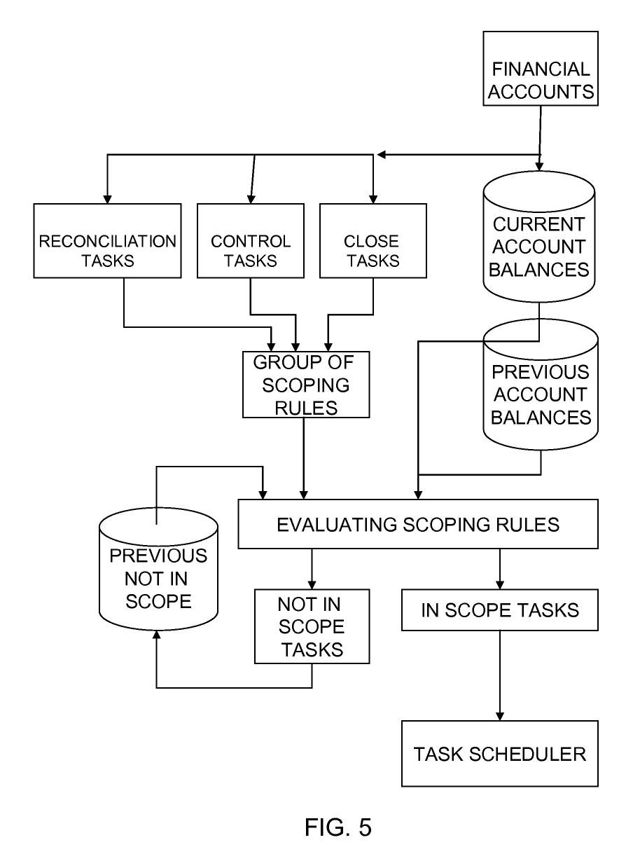

FIG. 6 is a flowchart for scoping conditioned by business entities

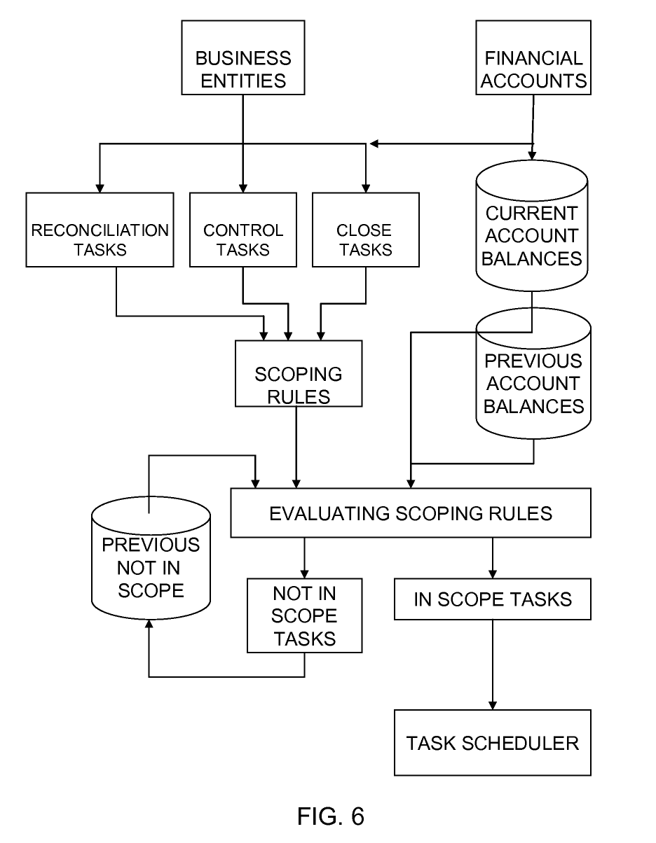

FIG. 7 is a flowchart for scoping using groups

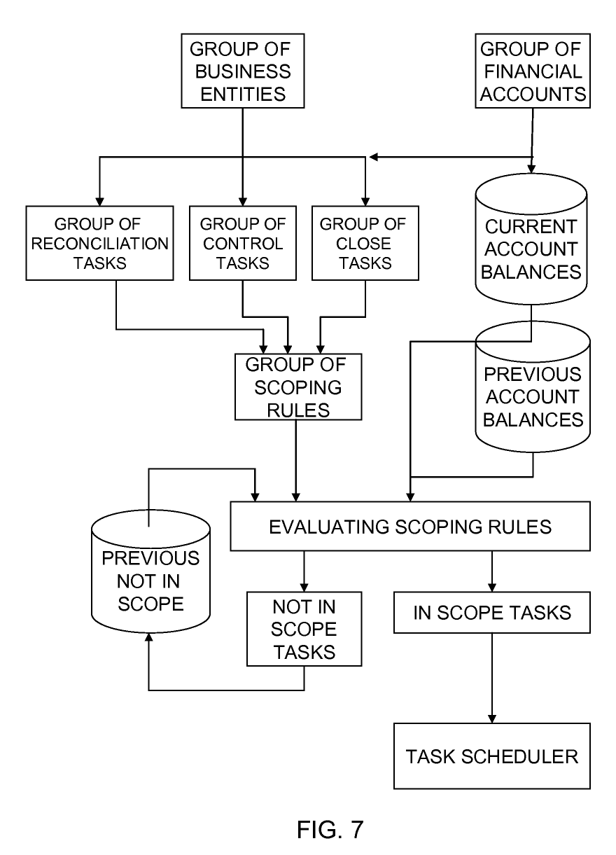

FIG. 8 is a flowchart for scoping with user override of profiles.

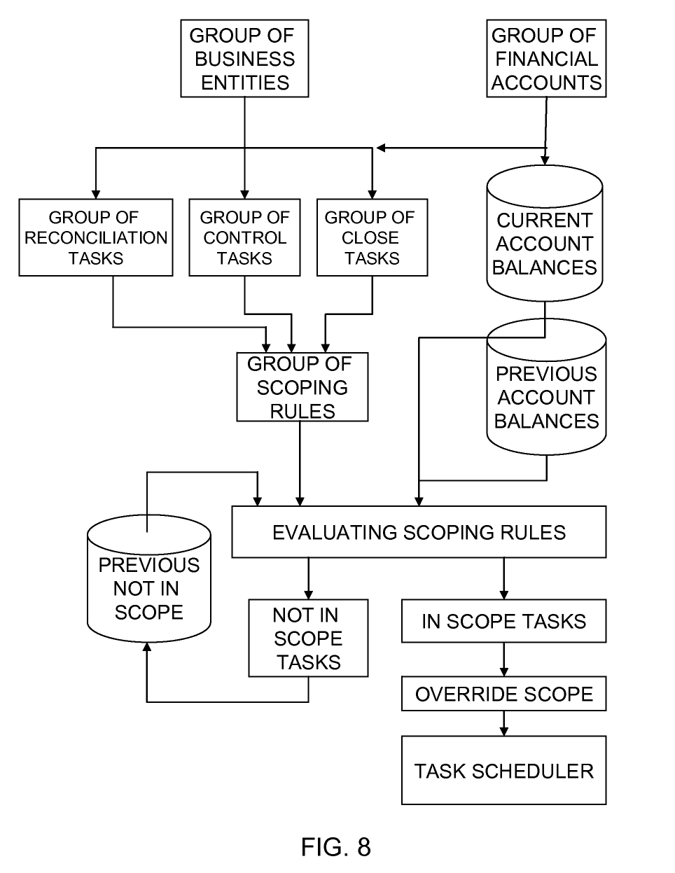

Each of these requirements is described at length in the sections that follow.

Financial statement account amounts for business units

A method for determining whether or not a control is worthy of being in scope is comparing a value of its associated financial statement account with a key criteria.

Update financial statement account types

The financial statement account type comprises the following initial values: Current Asset, Current Liabilities, Asset, Liabilities, Revenue, Expense, and Equity.

Scoping Rules

A scoping rule defines a heuristic to determine whether or not a financial task is in scope.

Scoping Profiles

A scoping profile displays the result of evaluating scoping rules

In Scope Aware Scheduler

The scope aware scheduler launches tasks that are pertinent to an enabled profile.

The present invention further comprises

Snap-shots of scoping profiles over time.

Every modification to a scoping profile requires a snapshot of the entire profile. This is needed to facilitate future enhancements to the feature as well as provide a mechanism so that reports regarding scoping may be authored readily. When adding this feature, we want to snapshot the profiles and the uploaded data.

Support additional rule capabilities—For example, for a selected account for a selected BU, if current period $ is greater than or equal to prior period $ amount by 10% (a user-defined percentage), then in scope.

Support Scoping Scenarios. These are essentially groups of Scoping rules that can be swapped in and out easily.

In an embodiment scoping decisions are based on the percentage difference between the previous and current amounts uploaded.

Scoping Profile

Users activate/deactivate scoping profiles to override the results of evaluating scoping rules by navigating to the appropriate profile for the control type they are interested in.

On the profile screen, next to the Save button, is a button labeled Activate or Deactivate depending on the state of the profile. If it is currently Activated, the button reads Deactivate, and vice versa.

When a profile is activated, all business units of the profile's control type that are marked out of scope per the criteria on the profile are not scheduled. For the case where multiple Business Unit/FSA tuples exist for a given control, the control is IN SCOPE if any of the matching tuples are in scope.

There are two ways a task can fall out of scope for a given business unit:

Its associated business unit is out of scope.

All of its associated financial statement account, business unit tuples are deemed out of scope.

Transactions relate to a particular business unit via its definition's business unit configuration (All business units, Selected business units, Selected business unit categories) as well as through its definition's ancestor's relationship to financial statement accounts. A transaction related to a financial statement account if any of the transaction's definition's ancestor is related to the given financial statement account.

Activating/deactivating a scoping profile has an immediate effect. Those controls that fall out of the boundaries of the scoping profile's criteria are effectively in scope.

Users designate accounts in scope/out of scope by navigating to the appropriate profile for the control type they are interested in.

Financial statement account, business unit tuples are automatically calculated via the associated scoping rule. For example, suppose that the selected rule pertains to Liability accounts for the Manufacturing business unit. Because of this rule, all financial statement accounts of Liability type associated with the Manufacturing business unit will be presented.

Based on the scoping rule, a recommendation is communicated to the user and a control designating whether or not a tuple is or out of scope is pre-selected.

When a user decides to make a decision that goes against the scoping rule's recommendation, a comment is recorded. When the scoping decision is consistent with the recommendation, the comment is removed on Save/Activate

While the scoping Profile screen shows current recommendations based on the latest uploaded financial statement account, business unit tuples, any changes take affect:

For a deactivated scoping profile: Changes may be saved, but don't take affect until the profile is activated

For a currently activated scoping profile: Changes take affect when Saved.

Users add or remove out of scope business units by navigating to the appropriate profile for the control type they are interested in.

Users may designate entire business unit associations out of scope. When a business unit is designated out of scope, any tuple designated as part of an account is automatically designated out of scope and the associated HTML control is disabled.

If a business unit is removed from the out of scope list, corresponding tuples can once again be designated as in scope.

Scheduler

The scheduler works by finding a list of each control definition that is scheduled for the current day. For each control, it queries the list of linked units and initiates the control for each enabled unit.

If the Scoping feature is disabled, in affect, all controls are always in scope.

Explicitly listed out of scope business units are skipped

Business Units for which scoping rules have been setup may be skipped

Since a control may be linked to any number of Financial Statement Accounts, there may be a list of Scoping Rules that apply to a given Business Unit for a given control If ANY of these Scoping Rules are currently IN scope, then the control is in scope for that business unit and should be executed

Methods

The present invention further comprises the methods,
Returning a list of scoping rules that have the given action plan type.
This API can be used in the “[control type] Profile” detail page for
populating the “Scoping Rule” dropdown.
Returning a list of FSA-unit tuples along with necessary information given
a rule id.
This API can be used to populate the “Accounts” section of a “[control type]
Profile” page when a different option is selected from the “Scoping
Rule” dropdown.
Returning a list of FSA-unit tuples along with necessary information given
a profile id.
This API can be used to retrieve data for populating the “Accounts” section * of a “[control type] Profile” page.
Returning a list of action plans for the given FSA and unit.
This API can be used to get the counts of action plans for the “Accounts”
section of a “[control type] Profile” page.
Returning a list of “out-of-scope” units for a given profile.
This API can be used to retrieve data for populating the “Out of Scope
Units” section of a “[control type] Profile” page.

### EMBODIMENTS

A method for financial process automation comprising two distinct but interrelated processes, wherein the first process comprises scheduling financial tasks, assigning tasks to personnel, tracking the timely completion of tasks, and escalating late tasks to supervisory personnel according to a financial calendar, and wherein the second process comprises scoping financial tasks, evaluating rules for scoping, enabling the visibility of tasks to the scheduling process according to changes in financial account balances.

The first process operates to schedule according to a financial calendar those tasks which are presented as scoped-in by the second process. The second process operates to determine a task is scoped-in by evaluating a rule forcing a task, all tasks connected to a financial account of a business unit, or all tasks connected to all financial accounts of a business unit to be scoped-in; a rule evaluating a comparison of at least one financial account with at least one of a fixed value, a previous period value, and the value of a second financial account; or a rule randomly selecting a task to be scoped-in.

The process for scoping financial tasks whereby a scoped-in task is visible to the scheduling process and a scoped-out process requires no attention by the scheduling process, comprises the steps of evaluating a rule comparing a first financial account balance with a second financial account balance when either of the financial account balances is updated with current values, evaluating a rule comparing a current financial account balance with a previous financial account balance when the financial account balance is updated, evaluating a rule comparing a financial account balance with one of a stored value or an average value for the same financial account balance when the financial account balance is updated with a current value.

A rule can also be true if the account balance is just different from the previous, or if just less than the previous, or if more, or if some percentage change happens either direction, or compares to another account in some fashion, etc. In an embodiment a rule could be defined that just uses the current balance . . . is it zero, non-zero, over a certain amount, under a certain amount.

Financial tasks comprise the following: reconciliations between accounts, financial period close tasks, and financial controls. In the present invention financial tasks are associated with certain financial accounts which are organized by business entity or business unit. If financial accounts are relatively insignificant in value and unchanging, it may be prudent to minimize the resources assigned to scheduling and performing financial tasks associated with them but this decision should be logical and traceable.

The present invention submits a list of financial control tasks or a list of account reconciliation tasks to be scheduled and assigned to individual actors in specific business units or enterprises by designating them “scoped in”. Or in some cases it may be an embodiment of the same invention to submit a list of financial control tasks or a list of account reconciliation tasks to be excluded from the immediate scheduling and assigning process by designating them “scoped out”. The method of designating a task either “scoped in” or “scoped out” comprises linking each financial account to the business units where the account is pertinent. Further, it comprises linking each business unit to the financial controls which are useful and substantive for the nature of their business.

And of course each financial account is linked to the specific control tasks and reconciliation tasks that apply to it. Finally, the system examines a body of rules that determine the frequency of applying the tasks to each combination of financial account and business unit resulting in the final determination of the “scoped in” or “scoped out” designation.

In scoping in a business unit, all of the tasks related to financial controls or account reconciliations for that business unit are scoped in as a result and tasks are assigned. In an embodiment, all tasks are at default scoped out. Any rule that scopes in a task overrides all others and no further evaluation of scoping rules on that task need be evaluated. In an embodiment, tasks could default scoped in and rules scope out.

In an embodiment, a rule would identify a business unit, a financial account, at least one financial task, and a computation comparing the current balance of the account with a metric, another financial account, or a previous balance of a financial account. which if true would be scoped in for scheduling and assignment.

A financial accounting task is put in view of the scheduler if the task is scoped in, else the task will be masked from the scheduler. The invention comprises a computer implemented method for scheduling and tracking the performance of a financial accounting task. The invention further comprises a computer implemented method for scheduling and tracking the performance of an account reconciliation. The method further comprises linking one of a business unit and a business entity to at least one of a financial control and an account reconciliation.

The method further comprises linking at least one of a financial account to at least one of a business unit, a financial control, and an account reconciliation.

The method further comprises submitting one of a financial control task and an account reconciliation task to a user having the ability to override the properties of quote scope in and quote scope out. The method further comprises enabling a user to permanently attach at least one of the property of “scope in” and “scope out” to at least one of a financial control task and an account reconciliation task.

The present invention comprises a method comprising defining a rule to assign at least one of the properties of “scope in” and “scope out” according to the values of a financial account balance, a business unit and a financial account and executing the rule when new values of account balances are uploaded.

The method further comprises overriding a scoping rule comprising the method of assigning one of the property “scope in” and “scope out” to one of a financial control task, and an account reconciliation task.

The method further comprising at least three of evaluating a scoping rule at scheduled intervals according to the value of a financial account, assigning a property of scoped in to one of a financial control and an account reconciliation, assigning a property of scoped out to one of a financial control and an account reconciliation, submitting a financial control with the property scope in to a scheduler, and submitting an account reconciliation task with the property scoped in to a scheduler.

The method of scheduling an account reconciliation process according to a computer implemented step of reading at least one of the property scoped in and scoped out, wherein the value of the property is determined by evaluating a scoping rule applied to a financial account of the business unit.

The method of scheduling a financial control process according to a computer implemented step of reading at least one of the property scope in and scoped out, wherein the value of a the property is determined by evaluating a scoping rule applied to a financial account of a business unit.

The invention comprises a method for a computer implemented process automation scheduling of at least one of a financial control task and an account reconciliation task, the method comprising evaluating a scoping rule based on the present or historical values of a financial account in at least one business unit to assign the value of a scoping property; and putting at least one of a financial control and an account reconciliation into the view of the process automation scheduler according to the value of a scoping property. In an embodiment, operators may override process automation rules.

Although particular embodiments of the present invention have been shown and described, it will be obvious to those skilled in the art that changes and modifications may be made without departing from the present invention in its broader aspects, and therefore, the appended claims are to encompass within their scope all such changes and modifications that fall within the true scope of the present invention.

### CONCLUSION

The present invention adds a scoping method to a conventional process automation scheduling method wherein the scheduler obtains visibility exclusively to tasks which are “in-scope” in based on rules. A rule may apply to a task and a type of business unit. A rule may apply to a type of task and a business unit. The present invention further comprises applying a rule to at least one financial account of a business unit whereby a plurality of tasks is attributed “in-scope” on a conditional basis for visibility to the scheduler.

The benefit of the present invention reduces the load on a scheduler, makes rational and traceable record of decisions to perform conditional tasks, and eliminates thousands of decisions and thousands of manual tasks from being performed without need.

The domain of applying this invention includes the financial reporting cycle, the financial period close, reconciliations of accounts, tax preparation, compliance with government regulations, and audit.

What is claimed is:

1. A system for process automation of financial accounting organization comprising a method tangibly embodied as a software program product encoded on computer-readable media comprising the following steps: controlling a financial task, accessing a financial account, and evaluating a scoping rule wherein a scoping rule specifies conditions under which a financial task is determined to be “in-scope” whereby a process automation scheduling system is made aware of the task as a candidate for assignment to an actor and a calendar.

2. The system of claim 1 wherein a financial account further comprises a financial account balance tangibly embodied as a numerical value of monetary units encoded on a computer-readable media.

3. The system of claim 2 wherein a financial account balance further comprises a current financial accounting period balance and at least one previous financial accounting period balance.

4. The system of claim 3 further comprising a record of at least one task encoded on computer readable media of a determination of being “in-scope” or not “in-scope” for at least one previous period whereby a scoping rule may use the previous history as a factor in determining the current determination of being “in-scope” or not “in-scope”.

5. The system of claim 4 wherein a financial task comprises at least one of a financial period close task, a financial account reconciliation task, and a financial control task.

6. The system of claim 5 further comprising a plurality of business entities wherein financial accounts are associated with business entities each having a financial accounting system, and wherein tasks are associated with business entities having personnel who may be assigned and scheduled to perform the tasks whereby evaluating a scoping rule results in a certain financial accounting task for a certain financial account to be scheduled for performance within a certain business entity by its personnel.

7. The system of claim 6 further comprising groups of financial tasks, groups of financial accounts, groups of scoping rules, and groups of business entities and further comprising task type, account type, rule type, and entity type, wherein a type may be a string or number denoting membership in a group and wherein a scoping rule group may be evaluated for at least one of a task group, an account group, and a business entity group whereby a plurality of tasks may be designated “in-scope”.

8. The system of claim 7 wherein a scoping rule comprises at least one of the following steps: whereby a task may be determined to be “in-scope” or not “in-scoped”.

9. The system of claim 8 further comprising the steps of displaying a list of tasks determined to be “in-scope” and displaying a control enabling the user to override the determination of a task being “in-scope” whereby tasks are not automatically scheduled without approval.

10. A method for financial process automation comprising a first process and a second process, wherein the first process comprises scheduling financial tasks, assigning tasks to personnel, tracking the timely completion of tasks, and escalating late tasks to supervisory personnel according to a financial calendar, and wherein the second process comprises scoping financial tasks, evaluating rules for scoping, enabling the visibility of tasks to the scheduling process according to changes in financial account balances.

11. The method for financial process automation of claim 10 wherein the first process operates to schedule according to a financial calendar those tasks which are presented as “in-scope” by the second process, and wherein the second process operates to determine a task is “in-scope” by evaluating at least one of the following: a rule forcing a task, all tasks connected to a financial account of a business unit, and all tasks connected to all financial accounts of a business unit to be “in-scope”; a rule evaluating a comparison of at least one financial account with at least one of a fixed value, a previous period value, and the value of a second financial account; and randomly selecting a task to be “in-scope”.

12. The second process of claim 11 for scoping financial tasks whereby a task determined to be “in-scope” is visible to the first process for scheduling and a task determined to be not “in-scope” requires no attention by the first process for scheduling, the scoping process comprising at least one of the steps of evaluating a rule comparing a first financial account balance with a second financial account balance when either of the financial account balances is updated with current values, evaluating a rule comparing a financial account balance with a historical value of the same financial account when the financial account balance is updated with a current value, evaluating a rule comparing a financial account balance with one of a stored value and an average value for the same financial account balance when the financial account balance is updated with a current value.

13. A process for work flow automation of financial tasks comprising a scheduling method, and a scoping method,
wherein a scoping method comprises reading a list of financial accounts whose data has been uploaded, determining if a financial task is assigned the property “in-scope” because the scoping process has been overridden, determining if a financial task is assigned the property “in-scope” by evaluating a rule based on the data value of the account, wherein a scheduling method comprises reading the current date, reading a financial task which has been determined to be “in-scope”, comparing the current date to the financial task completion date, computing an offset to determine a start date, assigning a resource to the financial task, and tracking completion of the financial task.

14. The process of claim 13 further comprising an accounting method wherein an accounting method comprises linking a plurality of financial accounts to each part of a financial statement, linking a plurality of financial accounts to a business entity, performing financial control tasks, performing financial close tasks, and performing financial reconciliation tasks.

15. The process of claim 14 further comprising an overriding method, wherein an overriding method comprises at least one of assigning the property “in-scope” to at least one of all tasks related to Account=A, assigning the property “in-scope” to at least one of all tasks related to Business Entity=B, assigning the property “in-scope” to all tasks related to Accounts whose type=T wherein A, B, and T may be settable by a user on a list recorded on a computer readable media.

16. The process of claim 15 further comprising a business rule evaluation method, wherein evaluating a business rule comprises reading current and historical values for the balance of at least one a financial account and computing a value based on a rule and setting the property “in-scope” as a function of the computation.

17. The method of claim 16 further comprising
assessing propinquity of financial tasks,
wherein assessing propinquity of financial tasks comprises making each financial task associated with a financial account of a business unit which has the property of “in-scope” visible to a scheduler having recognition of the present calendar, past history of tasks initiated, and access to the definition of a financial task with scheduling specifications.
